(19) United States
(12) Patent Application Publication
(10) Pub. No.: US 2018/0184849 A1
(43) Pub. Date: Jul. 5, 2018

(54) GRILLED SANDWICH SHAPE PROTECTOR

(71) Applicants: Lori Hayward, Carrollton, TX (US); Alandruis Dewayne Hayward, Carrollton, TX (US)

(72) Inventors: Lori Hayward, Carrollton, TX (US); Alandruis Dewayne Hayward, Carrollton, TX (US)

(21) Appl. No.: 15/862,625

(22) Filed: Jan. 4, 2018

Related U.S. Application Data
(60) Provisional application No. 62/442,973, filed on Jan. 5, 2017.

(51) Int. Cl. A47J 43/20; A21D 13/32; A23L 5/10

(52) U.S. Cl. CPC A47J 43/20; A23V 2002/00; A23L 5/10; A21D 13/32

(57) ABSTRACT

A flexible mold device for preserving sandwich shape and height while cooking and grilling. The grilled sandwich shape protector is a mold for a sandwich to prevent the flattening of the sandwich stack while the outer surfaces of the sandwich are grilled. The device consists of a mold with an inner lip to secure the food and an optional handle at the exterior edge. Grilling can occur via stove top skillet, stove top griddle, dual panel grill device, or an outdoor grill. With the grill mold, the sandwich contents will not fall out of the sandwich while the sandwich heats or when the sandwich is flipped to expose the opposite side of the sandwich to the heated grilling surface. The grill mold is made of food grade, durable material so that the sandwich or its content are not contaminated and remain safe for human consumption.

The present disclosure relates generally to a device for stabilizing stacked food during stovetop cooking.

### BACKGROUND

Sandwiches are an easy, affordable and convenient food item. Many people prefer the bread on their sandwich grilled or toasted. If the bread is toasted separately from the contents, the contents may not be warm or the sandwich maker will have the hassle and inconvenience of using separate containers to heat the sandwich contents and the sandwich bread and then reassembling the sandwich. For those who choose to use panini grills, George Foreman, Cuisine Art Griddler or other grills with dual panels, the sandwich will be flattened considerably and lose its original shape once the sandwich is pressed between the panels of the grill. There is also the risk of the contents falling from the sandwich while the sandwich is pressed between the grill panels. A consumer also has the option of preparing a grilled sandwich on the stovetop with a skillet or griddle, however, this option requires more time since the sandwich can only be grilled one side at a time and more energy since the stovetop must be heated sufficiently. For those consumers who enjoy flattened sandwiches, the flattened, grilled sandwich does not present an issue. For those consumers who desire a grilled sandwich that is not flattened but don't want the hassle of heating the bread and contents separately or using the stove top, there exists a need for a device that can facilitate grilling both sides of the bread and heating contents while maintaining the height and structure of the sandwich as well as the integrity of the contents of the sandwich.

### OBJECTIVES

An object of one embodiment of the present disclosure is to provide a device for producing a grilled sandwich that retains its original height and shape and the integrity of the sandwich contents.

Another object of the present disclosure is to provide a device for simultaneously grilling both slices of sandwich bread and heating contents without altering the height of the sandwich.

Another object of the present disclosure is to provide a device for simultaneously grilling the sandwich bread and heating contents without altering the height of the sandwich.

Another object of the present disclosure is to provide a device for producing a grilled sandwich without disturbing or displacing the contents of the sandwich.

Another object of the present disclosure is to provide a device which protects the height of the sandwich while a user presses and pats the sandwich during cooking.

Another object of the present disclosure is to provide a sandwich making device that is nonstick and easy to clean.

### SUMMARY

Embodiments of the present disclosure, the grilled sandwich shape protector (the “GSSP”), generally provide a device for producing a grilled sandwich while preserving the original height and shape of the sandwich as well as the integrity of the contents within the sandwich. In use, a user would place a sandwich inside the GSSP, place the GSSP with sandwich on the grill press and close the grill so that the plates of the grill are above and below the GSSP. The user would then follow the grill manufacturer directions for food preparation. Alternatively, if only one grilling surface is available, the GSSP with sandwich or other food inside would be placed on the cooking surface and later flipped to continue cooking the opposite surface of the sandwich. Once the sandwich has reached the desired level of doneness, the user would remove the GSSP with sandwich from the grill. An optional element of the GSSP is handles at the exterior edge of the GSSP to assist with removal from the cooking surface. The GSSP would be removed and the user will have a grilled sandwich of basically the same height and shape as its pre-grill condition. Even if the user presses or pats the sandwich, with the GSSP, the sandwich will retain it's the majority of its height since the GSSP prevents excessive compression of its contents. In addition, the contents of the sandwich remain secure inside the sandwich since the sandwich is surrounded by the GSSP while on the grill. By contrast, with a common stovetop preparation of a grilled sandwich, contents may fall from the sandwich as the sandwich is flipped to grill the opposite side.

The GSSP is constructed from a single piece, multiple pieces, of food grade liquid silicone rubber (“LSR”), which is nonstick and easy to clean. Liquid silicone rubber is an elastomer which is highly durable and sturdy and suitable for industrial as well as residential use. LSR may be used for the construction of the GSSP since LSR is resistant to high-temperature, flexible, non-sticky, odorless, tasteless, mold resistant, bacteria resistant, and hydrophobic. It is to be understood that the GSSP can also be constructed from other sturdy materials such as aluminum, steel, brass or other material that are safe for contact with human food products and the heating element. The GSSP may also include a lip on one inner edge to prevent food items from slipping through the GSSP and one or more handles on the outer edges of the GSSP to facilitate removal of the GSSP from the cooking surface.

In order to additionally secure the food contents within the GSSP, the GSSP has a lip at the first inner edge of the device to prevent the food from slipping out of the GSSP and to further stabilize the shape and height of the food product. Without the lip, the GSSP may become disengaged from any food that is not snugly positioned within the inner borders of the GSSP. The opposite edge of the device does not have a lip. In use, the side of the GSSP with the lip will be adjacent to the cooking surface during use. Once the food in contact with the cooking surface has reached a desired level of doneness, the user can rotate the GSSP so that the opposite edge (without the lip edge) is in contact with the cooking surface. Once the opposite side of the food product has achieved the desired level of doneness, the user may remove the GSSP from the food by applying upward pressure or the food with GSSP may be removed from the cooking surface prior to the removal of the GSSP.

Other technical features may be readily apparent to those skilled in the art from the following figures and descriptions.

### BRIEF DESCRIPTION OF THE DRAWINGS

For a more complete understanding of this disclosure and its features, reference is now made to the following description, taken in conjunction with the accompanying drawings, in which:

FIG. 1 shows the perspective view of the sandwich protector.

FIG. 2 shows the front view of the sandwich protector.

FIG. 3 shows the front view of the sandwich protector.

FIG. 4 shows the top view of the sandwich protector

FIG. 5 shows the bottom view of the sandwich protector.

FIG. 6 shows the sandwich protector on a one sided heating element.

FIG. 7 shows the sandwich protector on a two sided heating element.

### REFERENCE NUMBERS

(1) Curved wall
(2) Straight side wall
(3) Straight bottom wall
(4) Curved corner
(5) Lip
(6) Handle
(7) Sandwich
(8) Cooking element

### DETAILED DESCRIPTION

The present disclosure generally provides a grilled sandwich protector used for producing a grilled sandwich which maintains its original shape and height after grilling.

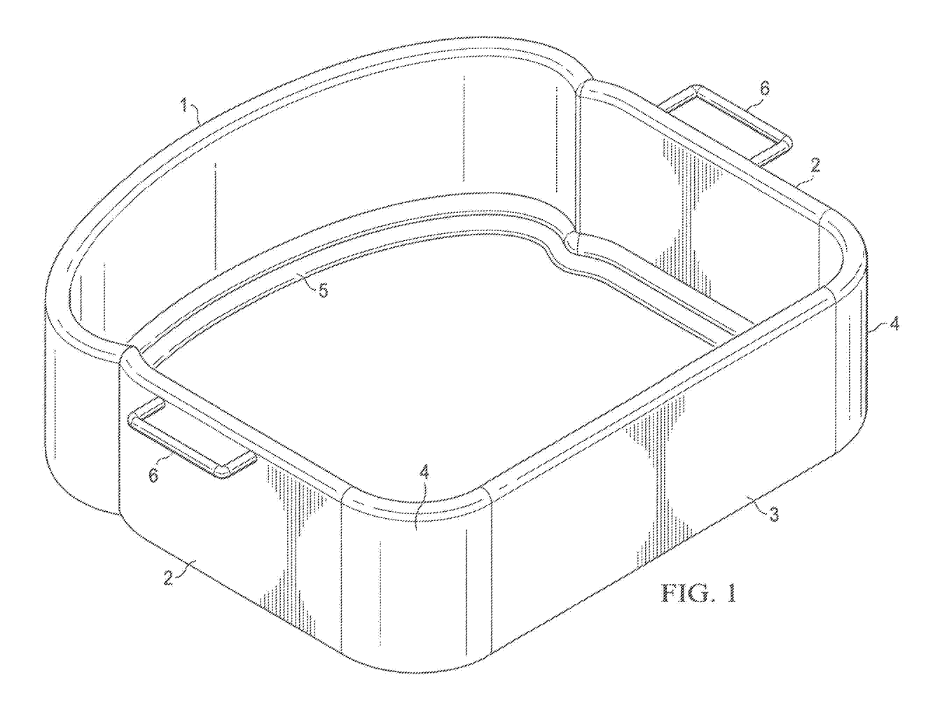

FIG. 1 shows a perspective view of the GSSP. The GSSP is constructed from a length of material and shaped to fit around the exterior edges of a sandwich. The GSSP may be constructed of a single length of material or from the attachment of four walls 2,3 and two curved corners 4 into the GSSP. In this embodiment, the GSSP includes three straight edge walls 2,3, one curved edge wall 1, and two curved corners 4. A pair of straight edge side walls 2 forms the sides of the GSSP, the third straight edge wall 3 forms the bottom, and the curved wall 1 forms the top. The curved corners 4 connect the bottom straight edge wall 3 to the pair of straight edge side walls 2. The shape of the GSSP mimics a slice from a common loaf of bread but the GSSP can be formed in additional shapes. The GSSP may include a lip 5 on an inner edge of the device to further secure the food within the GSSP. The lip 5 ensures that a sandwich 7 does not fall or slip out of the GSSP when inserted to the GSSP for cooking. The GSSP also may include a handle 6 on an outer edge 2 of the device to aid in removal of GSSP from the heating element 8. Once the sandwich 7 is cooked sufficiently, the user may use the handle 6 to remove the GSSP from the cooking surface 8 or the user may use a spatula or other cooking tool to lift the GSSP from the cooking surface 8. The GSSP may be constructed of LSR or any material with similar properties. The GSSP will prevent the contents of a sandwich 7 from falling out of the bread. In addition, the GSSP used with a dual panel grill system 8 allows a user to produce a grilled sandwich 7 while maintaining the original height and shape of the sandwich. A grilled sandwich 7 produced with a GSSP will not become flattened during grilling and will not lose any sandwich contents during cooking. Additionally, if the GSSP is used with a stove top (skillet or griddle) 8, no sandwich contents will be lost as the sandwich is flipped during grilling. The height of the GSSP is higher than a stack composed of bread, contents and bread. In the event the sandwich stack 7 is higher than the GSSP, the height of the sandwich will be at least as tall as the GSSP after cooking and pressing of the sandwich. While the present embodiment of GSSP is for traditional bread available in any common supermarket, the shape of the GSSP may be modified to accommodate French bread, baguette, croissants, pita, tortilla wraps or any other food product used to secure sandwich contents.

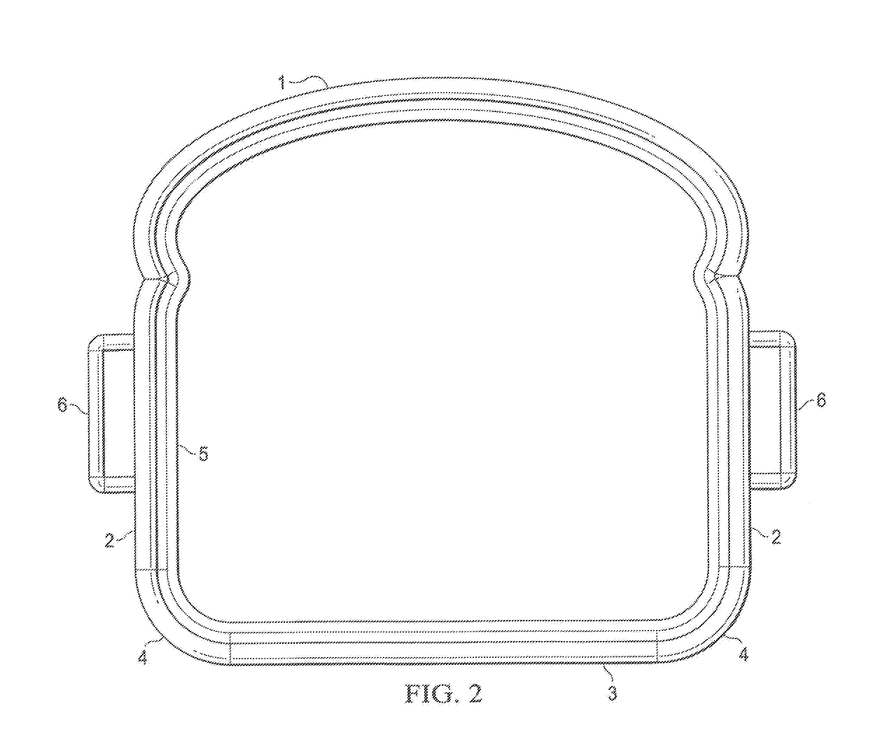

FIG. 2 shows a front view of the GSSP, shaped to fit around the exterior edges of a sandwich. The GSSP includes three straight edge walls 2,3, one curved edge wall 1, and two curved corners 4. The GSSP may include a lip 5 on an inner edge of the device to further secure the food within the GSSP. The GSSP also may include a handle 6 on an outer edge of the device to aid in removal of GSSP from the heating element 8. The GSSP will prevent the contents of a sandwich 7 from falling out of the bread since the GSSP surrounds the outer edges of the sandwich bread. GSSP used with a dual panel grill system 8 allows a user to produce a grilled sandwich 7 that will not become flattened during grilling and/or pressing and maintains the original height and shape of the sandwich.

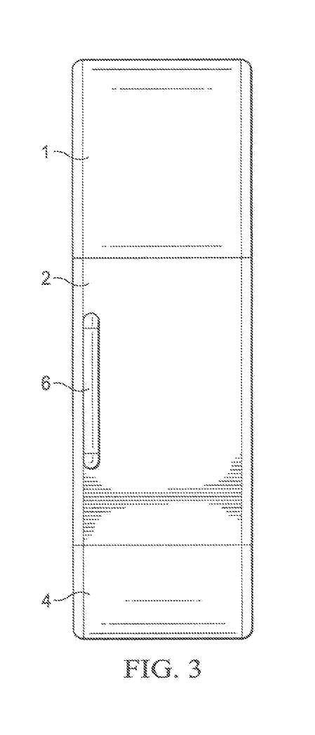

FIG. 3 shows a side view of the GSSP. This side view shows a curved corner 4 connected to a straight side wall 2 of the GSSP and the straight side wall 2 of the GSSP connected to the curved wall 1 of the GSSP. The handle 6 is connected to the exterior of the straight side wall 2.

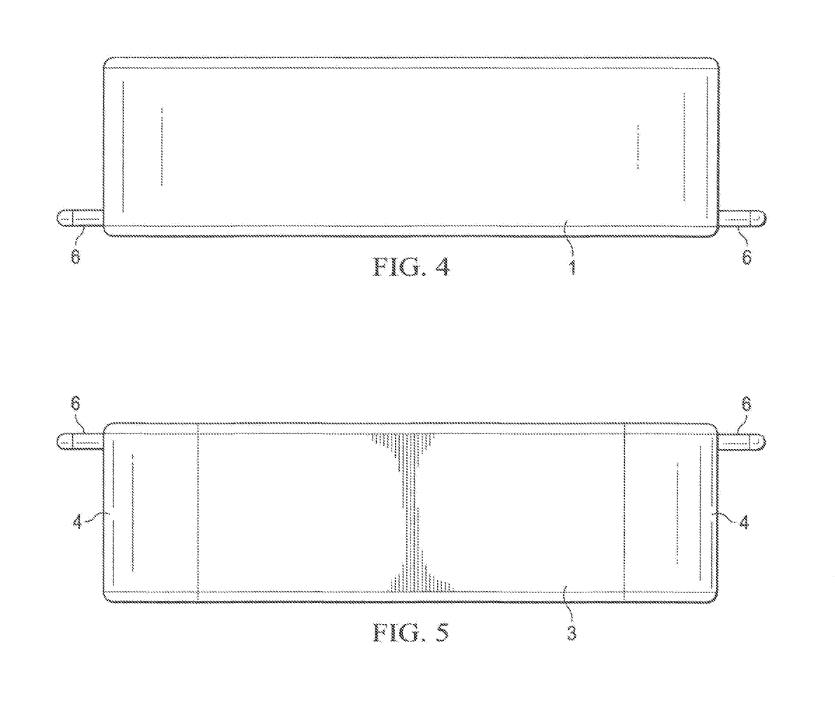

FIG. 4 shows a top view of the GSSP. This top view is the curved wall 1 of the GSSP. The handles 6 connected to the exterior of the straight side walls 2 are also visible.

FIG. 5 shows a bottom view of the GSSP. This bottom view is the straight wall 3 of the GSSP with two curved corners 4, which connect the straight bottom wall 3 to the straight side walls 2 of the GSSP.

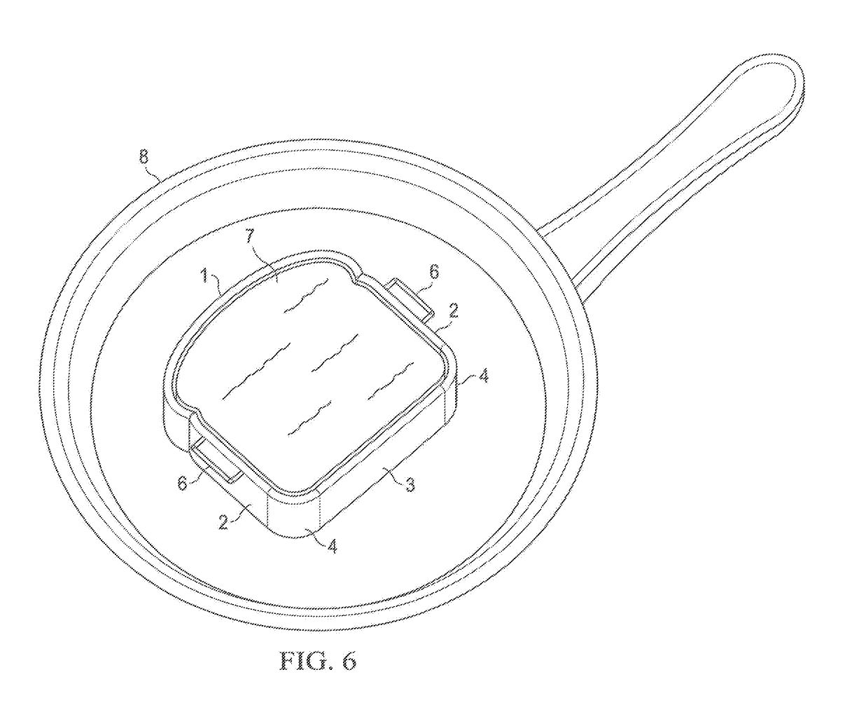

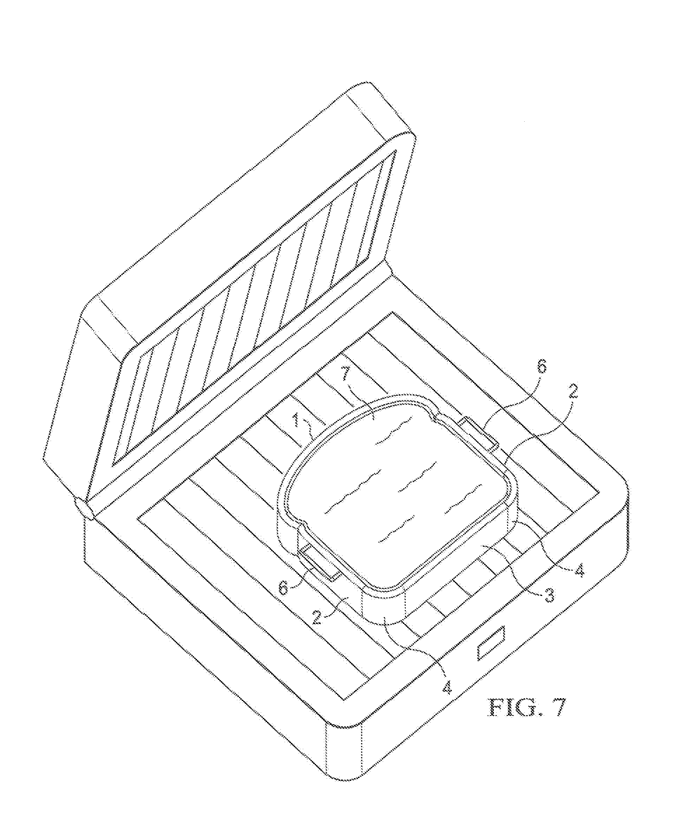

FIG. 6 shows the GSSP in a skillet. The GSSP includes three straight edge walls 2,3, one curved edge wall 1, and two curved corners 4 connecting the straight walls 2,3. The GSSP may include a lip 5 on an inner edge of the device to further secure the food within the GSSP. The GSSP also may include a handle 6 on an outer edge of the device to aid in removal of GSSP from the heating element 8. A sandwich 7 inside the GSSP and the GSSP on a skillet 8 are shown for illustrative purposes.

FIG. 7 shows the GSSP on a dual surface grill. The GSSP includes three straight edge walls 2,3, one curved edge wall 1, and two curved corners 4 connecting the straight walls 2,3. The GSSP may include a lip 5 on an inner edge of the device to further secure the food within the GSSP. The GSSP also may include a handle 6 on the exterior of the straight side wall 2 of the device to aid in removal of GSSP from the heating element 8. A sandwich 7 inside the GSSP and the GSSP inside a dual surface grill 8 are shown for illustrative purposes.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure and the following claims.

What is claimed is:

1. A grill mold for a sandwich comprised of:
A curved outer wall;
A pair of straight side walls;
A straight outer wall; and
A pair of curved corners.

2. The grill mold of claim 1,
wherein a first end of said curved outer wall connects with a first end of a first straight side wall, wherein a second end of said curved outer wall connects with a first end of a second straight side wall;
wherein a second end of said first straight side wall connects to a first end of first curved corner; wherein a second end of said second straight side wall connects to a first end of second curved corner;
wherein a first end of a straight outer wall connects to a second end of first curved corner;
wherein a second end of said straight outer wall connects to a second end of said second curved corner.

3. The grill mold of claim 2, wherein said grill mold is further comprised of a peripheral lip within the inner perimeter of said grill mold.

4. The grill mold of claim 3, wherein said peripheral lip is sufficiently thin to allow the majority of the contents of said grill mold to directly contact a grill surface on which said grill mold is placed.

5. The grill mold of claim 2, wherein said grill mold is further comprised of an exterior handle connected to said straight side walls.

6. The grill mold of claim 2, wherein said grill mold is constructed of material selected from the group consisting of silicone, silicone rubber, heat resistant plastic, aluminum, steel, and brass.

7. A grill mold for a sandwich comprised of:
A length of material, wherein said material is a food grade element, wherein said material is a continuous loop without an endpoint;
A lip within the interior of said length of material; and
A handle at the exterior of said length of material.

8. A method for producing a grilled sandwich with a grill mold comprising:
Placing food contents on a first slice of bread;
Placing a second slice of bread on said food contents to create a sandwich;
Placing said sandwich within the borders of the grill mold;
Placing said grill mold on a dual panel heated surface;
Rotating said grill mold such that an opposite side of said sandwich rests upon a single panel heated surface, when said dual panel heated surface is unavailable;
Removing said sandwich from said heated surface once said sandwich reaches the desired level of doneness.

9. The method of claim 8, wherein said heated surface is selected from the group consisting of: skillet, griddle, single surface grill, and dual panel countertop grill.
